(19) United States
(12) Patent Application Publication
(10) Pub. No.: US 2005/0047638 A1
(43) Pub. Date: Mar. 3, 2005

(54) Method and apparatus for processing X-ray image

(75) Inventors: Masakazu Suzuki, Kyoto-shi (JP); Takeshi Hayashi, Kyoto-shi (JP)

Correspondence Address: KODA & ANDROLIA, 2029 CENTURY PARK EAST, SUITE 1430, LOS ANGELES, CA, 90067-3024, US

(73) Assignee: J. Morita Manufacturing Corporation

(21) Appl. No.: 10/894,386

(22) Filed: Jul. 19, 2004

(30) Foreign Application Priority Data
Jul. 25, 2003 (JP) P2003-280060

(51) Int. Cl. G06K 9/00; G06K 9/36

(52) U.S. Cl. 382/132; 382/280

(57) ABSTRACT

In a method for processing a digital X-ray image data obtained by panoramic or cephalo-metric radiography, Fourier transforms are computed in a two-dimensional frequency space on the digital X-ray image data, and data of the Fourier transforms are multiplied by values of a mask having different frequency characteristics in two coordinate directions in the two-dimensional frequency space, the values being smaller than one around an origin in the frequency space. Then, inverse Fourier transforms are computed on the data of the Fourier transforms after the multiplication. A resultant image data in real space is provided for diagnosis.

### FIELD OF THE INVENTION

The invention relates to image processing of digital X-ray radiographs obtained in panoramic or cephalo-metric radiography.

### RELATED ART

Panoramic or cephalo-metric radiography is used in dental X-ray radiography. In panoramic radiography, an entire dentition or jawbone and its neighborhood are imaged in a single radiograph. For example, a slit-like X-ray beam generated by an X-ray source scans an object (or a patient) successively while moving a film in synchronization with the scan. Then an image of a slice plane is obtained. In cephalo-metric radiography, a head of a person or an object is fixed to keep a constant position relationship between the X-ray source and the object, and an entire object is imaged in a front view, a side view or the like.

The invention relates to image processing of digital X-ray radiograph. An example of a background art for such image processing is described in Japanese Utility Model laid open Publication 6-31704/1994 (Japanese utility model application 4-69546/1992) on MIP processing for an X-ray computerized tomography (CT) scanner. In the MIP processing, X-ray data is subjected to filtering in real space and Fourier transforms are calculated to provide data in frequency space. After limiting the frequency range with a frequency filter for band pass filtering or for band attenuation to delete signals and noises in unnecessary frequencies, the inverse Fourier transforms are calculated on the data in frequency space to provide data in real space. It is also known, as a smoothing technique of image data, that the image data are converted to Fourier transforms in frequency space and, after deleting high frequency components, the inverse Fourier transforms are calculated on the Fourier transforms.

In panoramic and cephalo-metric radiography, even when an object is exposed to X-rays uniformly, it is liable that a part or parts in the object are exposed insufficiently while other part or parts are exposed excessively, caused by a change in thickness for various parts in the object or a change in image density due to obstructive shadow. If a part or parts of a radiograph are too white or black, it cannot be used for diagnosis. Therefore, it is desirable to process imaging data in order to emphasize a feature of the image or to observe it easily.

In a panoramic radiography apparatus, automatic exposure is performed in order to make image density even, for example, by adjusting X-ray intensity by changing tube voltage (kV) and tube current (mA) of the X-ray tube for each section in an object or by changing the angular velocity of the rotary arm of the apparatus. For example, the tube voltage and tube current are adjusted according to a change in film speed between anterior teeth and posterior teeth in order to make the density even over the entire film. However, it is still a problem that a part or parts of a radiograph are still too white or black. As to a cephalo-metric radiography apparatus, a thickest part in an object has a much smaller X-ray transmission relatively to ambient air, so that a radiograph has a large dynamic range. However, it is difficult to observe an entire radiograph without changing contrast or intensity. Further, a similar problem occurs for panoramic and cephalo-metric radiography apparatuses using a charge-coupled device (CCD) sensor or the like, similarly to those using a film.

### SUMMARY OF THE INVENTION

An object of the invention is to provide an image suitable for diagnosis in panoramic and cephalo-metric radiography.

For processing a digital X-ray image data obtained by panoramic or cephalo-metric radiography, Fourier transforms are computed in a two-dimensional frequency space on the digital X-ray image data, and data of the Fourier transforms are multiplied by values of a mask having different frequency characteristics in two coordinate directions in the two-dimensional frequency space, the values being smaller than one around an origin in the frequency space. Then, inverse. Fourier transforms are computed on the data of the Fourier transforms after the multiplication. A resultant image data in real space is provided for diagnosis.

Preferably, a frequency, at which the value of the mask becomes one as frequency is changed from an origin in a first coordinate axis in the two-dimensional frequency space, is different from another frequency at which the value of the mask becomes one as frequency is changed from the origin in the other coordinate axis. For example, the first coordinate axis is horizontal coordinate axis and the other coordinate axis is vertical coordinate axis in the two-dimensional frequency space.

An advantage of the invention is that a radiograph obtained in panoramic and cephalo-metric radiography can be converted to a radiograph suitable for diagnosis.

### BRIEF EXPLANATION OD THE DRAWINGS

These and other objects and features of the present invention will become clear from the following description taken in conjunction with the preferred embodiments thereof with reference to the accompanying drawings, and in which:

FIG. 1 is a front view of an X-ray imaging apparatus;

FIG. 2 is a side view of the X-ray imaging apparatus;

FIG. 3 is a block diagram of an internal structure of a computer;

FIG. 4 is a flowchart of an image processing;

FIG. 5 is a diagram of an example of a two-dimensional mask;

FIG. 6 is a graph of u dependence of an example of a two-dimensional mask;

FIG. 7 is a diagram of a modified example of a two-dimensional mask;

FIG. 8 is a diagram of another modified example of a two-dimensional mask;

FIG. 9 is a diagram of an X-ray radiograph obtained in panoramic radiography before masking; and

FIG. 10 is a diagram of an X-ray radiograph obtained in panoramic radiography after the masking.

### PREFERRED EMBODIMENTS

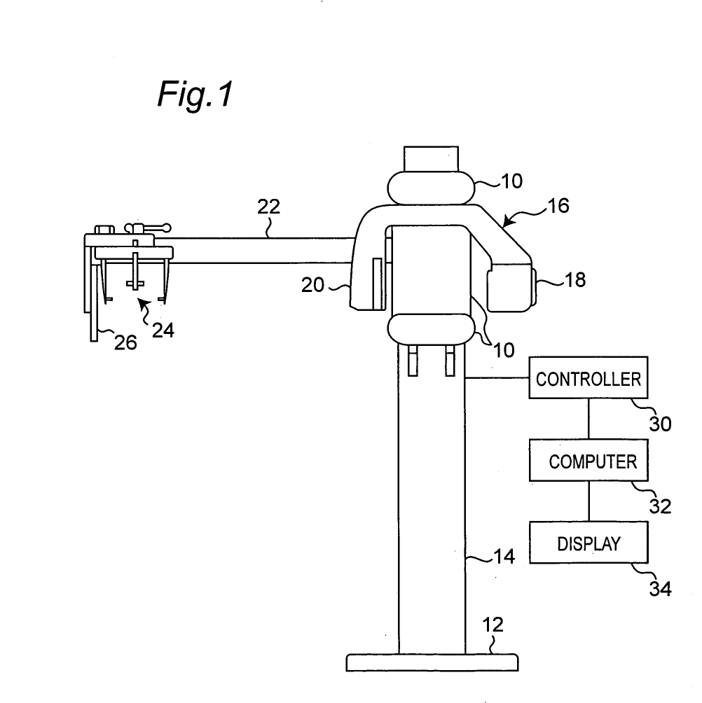

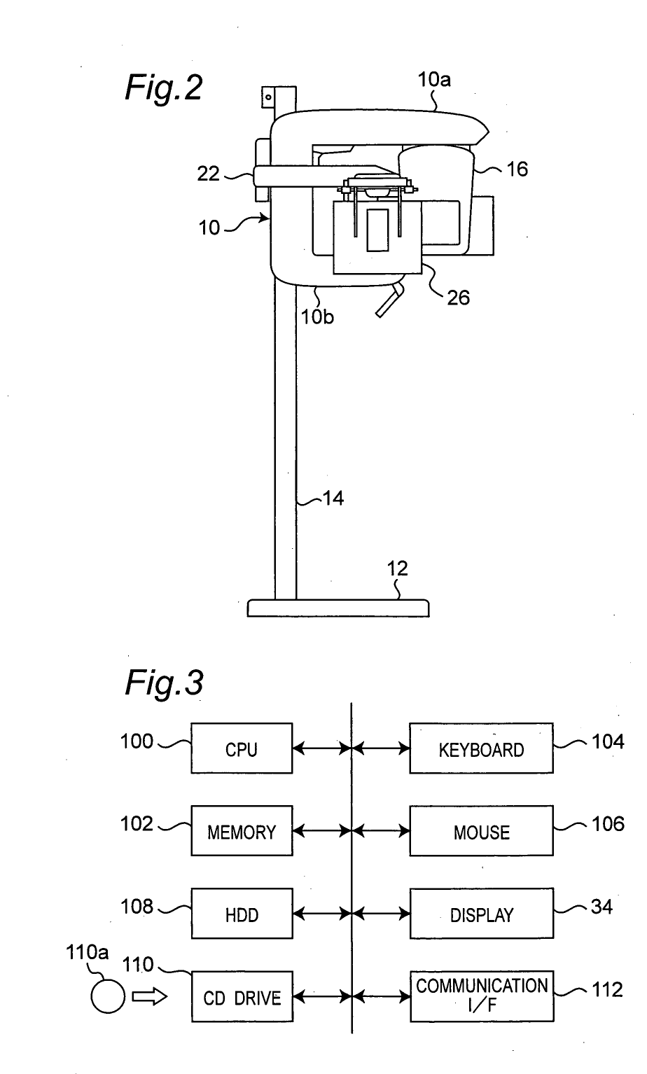

Referring now to the drawings, wherein like reference characters designate like or corresponding parts throughout the views, FIGS. 1 and 2 show an X-ray apparatus used for dental panoramic and cephalo-metric radiography. In this apparatus, a main body 10 of a lift has a central part in parallel to an upright support 14 fixed to a base 12 and upper and lower extensions 10a and 10b extending from the top and from the bottom of the central part towards the front of the apparatus. A lifting mechanism (not shown) is connected to the central part for moving the main body 10 up or down along the support 14. The upper extension 10a includes therein a device (not shown) positioning a patient. A rotary arm 16 is supported rotatably below the upper extension 10a. The rotary arm 16 has an X-ray head (X-ray source) 18 which generates X-rays and an X-ray sensor 20, such as a film, an imaging plate, a charge-coupled device (CCD) sensor, a metal-oxide-semiconductor (MOS) sensor or an X-ray fluorescent light photomultiplier. The X-ray head 18 is positioned oppositely to the X-ray sensor 20. At an end of the lower extension 10b there are provided a chin rest (not shown) for resting a chin of the patient and a plate (not shown) for supporting sides of the head of the patient. Further, for cephalo-metric radiography, a fixing device (ear lot) 24, for fixing a position of the patient, and an X-ray sensor 20 are provided at a top of an arm 22 provided in a lateral side of the support 14. Between panoramic radiography and cephalo-metric radiography, the angle and the position of at least one of the X-ray head and an X-ray sensor 20 are changed. The apparatus further includes a controller 30 for controlling the operation thereof, a computer 32 for generating a radiograph by processing data obtained by the X-ray sensor 20, 26, and a display device 34 for displaying the image, namely the radiograph.

In panoramic radiography, an object supported on the chin rest is fixed between the X-ray head 18 and the X-ray sensor 20. A slit-like X-ray beam is generated through a vertical slit (not shown) before an X-ray generator (not shown) while a rotary arm is rotated to scan the patient Successively and to acquire an image from the X-ray sensor in synchronization of the scan. The computer 32 processes imaging data from the X-ray sensor to provide a radiograph along a section plane.

Further, in cephalo-metric radiography, the head as an object is fixed at the front and side with the fixing device 24 so as to maintain the position relationship between the X-ray sensor 26 and the object always constant. Then, the X-ray head 18 generates X-rays to radiate the object, and an entire image of the object is obtained by the X-ray sensor 26.

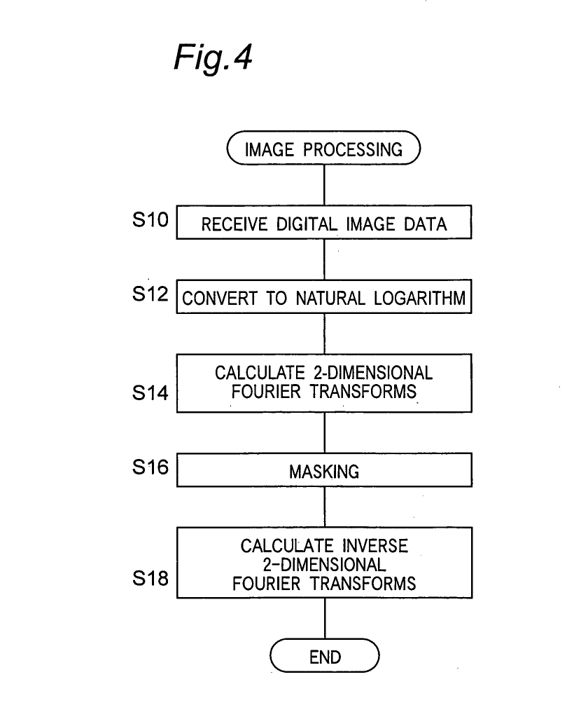

FIG. 3 shows an internal structure of the computer 32 including a central processing unit (CPU) 100 for controlling the entire computer 32, and memory devices (a read-only memory and a random access memory) 102 connected through a bus to the CPU 100. The CPU 100 is connected further to a keyboard 104, a mouse 106, a display device 34 a hard disk drive (HDD) 108 for storing programs and files and a communication device 112 for the communication with the external. A program for processing an X-ray image (FIG. 4) and a mask therefor are stored in a storage device such as a hard disk or a compact disk. The CPU 100 runs the program as will be explained later.

A storage medium for storing the program and the mask for the computer 32 may be a flexible disk or a various type of an optical disk, and if such a medium is used, a drive therefor such as a flexible disk drive or an optical disk drive is added for the computer 32.

As shown in FIG. 4, in the processing of a radiograph for a panoramic or cephalo-metric radiography, digital X-ray image data is acquired (step S10). For an apparatus using an imaging plate, an X-ray CCD sensor or the like, numerical data of the image can be obtained directly from the apparatus as digital X-ray image data. This invention can also be applied to digital data obtained by a digital image reader on an X-ray image on a film. That is, the X-ray image may be converted to numerical data or digital X-ray image data by a digitizing process. Because raw digital X-ray image data obtained by the above-mentioned processes is proportional to the intensity of transmitted X-rays, they are converted with use of natural logarithm to image data of linear integration on X-ray absorption coefficients (step S12). It means that the digital X-ray image data are obtained by logarithm transformation of data obtained by the X-ray sensor. The above-mentioned steps are known to be performed generally.

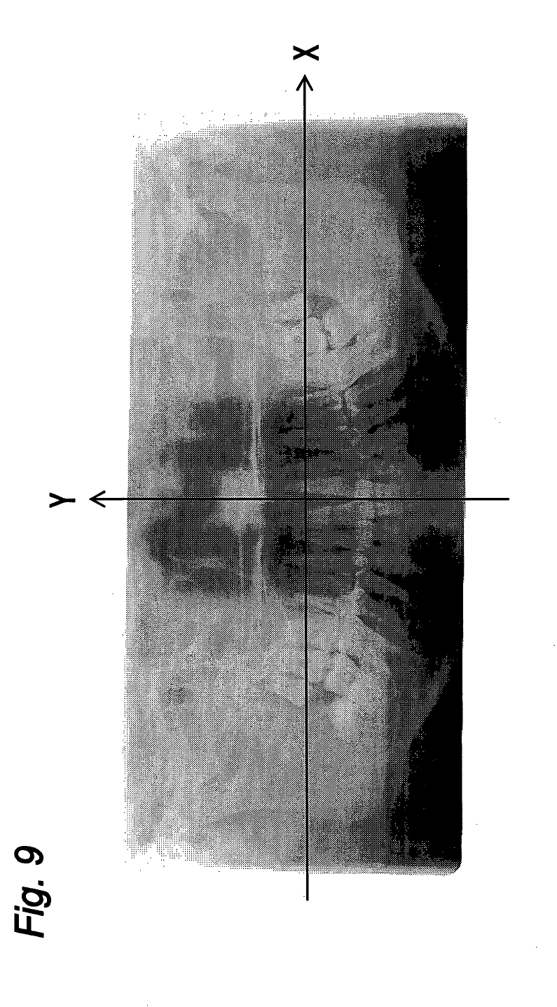

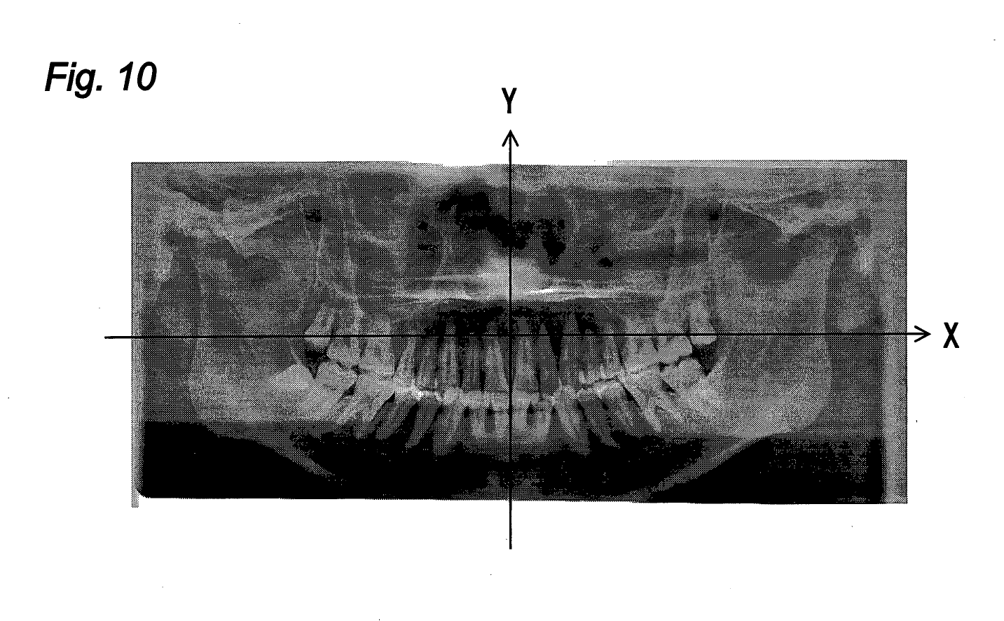

Next, the image data in real space represented with x and y coordinates are converted to two-dimensional Fourier transforms to provide data in a two-dimensional frequency space represented with u and v coordinates (step S14). When a face is observed at the front, it is assumed that x and y coordinates in an image are horizontal (perpendicular to a central line in parallel to y direction in FIGS. 9 and 10 and in parallel to a direction combining the two earholes) and vertical (in parallel to the central line), respectively. Then u and v coordinates represent frequencies in the horizontal and vertical directions, respectively. Next, the data in the two-dimensional frequency space are masked with frequency characteristics different between the horizontal direction (u) and vertical direction (v) (step S16). That is, the data in the two-dimensional frequency space are multiplied by values in a mask which is a high pass filter to reduce low spatial frequency components in the original image. The above-mentioned masking is not for deleting unnecessary portions, but to multiply the image data by the values in the mask. Next, the data subjected to the masking are converted to inverse Fourier transforms to provide resultant image data in x and y coordinates in real space (step S18). The image obtained as mentioned above is provided for diagnosis.

As explained above, the computer 32 (a) computes the Fourier transforms in the two-dimensional frequency space on the digital X-ray image data, (b) multiplies the data of the Fourier transforms with values of the mask having different frequency characteristics in two coordinate directions in the two-dimensional frequency space, and (c) computes the inverse Fourier transforms on the data of the Fourier transforms after the multiplication to provide a resultant image data in real space. However, generally, a first computer may be provided to compute the Fourier transforms, a multiplier may be provided to perform the multiplication, and a second computer may be provided to compute the inverse Fourier transforms on the data of the Fourier transforms after the multiplication.

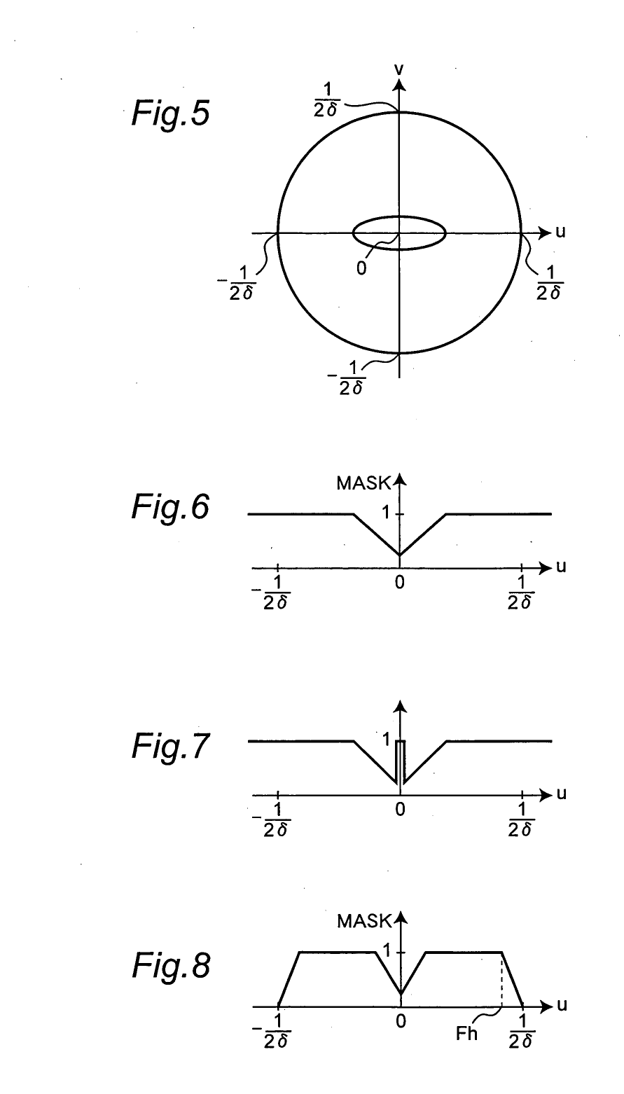

It is to be noted that a form of the mask to be used for the masking at step S16 is important. Data in frequency space represented in u and v coordinates, obtained as Fourier transforms of image data represented in x and y coordinates, is subjected to masking with different frequency characteristics in the vertical (v) and horizontal (u) directions, as shown in FIG. 5, wherein 1/2δ denotes Nyquist frequency. Because the frequency characteristic is different in the two directions, an image having a too white or black direction can be converted to a more isotropic image or an image easy to observe.

FIG. 5 shows an example of a mask wherein frequency characteristics are different between vertical and horizontal directions. As to the mask, the value at the origin is set to a numerical value smaller than one, for example, between 0 and 0.5, and the value of a point in the mask is increased gradually towards one as the point leaves from the origin. In an example shown in FIG. 6, the value is increased linearly. The value of the mask is set to one at the surrounding distant from the origin. That is, the values distant from the origin or high frequency components are not changed or kept constant. On the other hand, low frequency components are reduced because the mask has values smaller than one near the origin. Because the value is increased gradually from the origin to the surrounding, the lower frequency components can be reduced more.

The value Fx of u coordinate at which it reaches to one when u is changed from the origin is different from the value Fy of v coordinate at which it reaches to one when v is changed from the origin. That is, the value of the mask is increased in the horizontal direction so that it reaches one at ±Fx of spatial frequency, while increased in the vertical direction so that it reaches one at ±Fy of spatial frequency. Generally Fx is not equal to Fy.

For a panoramic or cephalo-metric radiograph, an image suitable for diagnosis can be obtained when Fx>Fy>0. In other words, a frequency, at which the value Fx of the mask becomes one as frequency is changed from the origin in a horizontal coordinate axis, is larger than a frequency, at which the value Fy of the mask becomes one as frequency is changed from the origin in a vertical coordinate axis. When a face is observed at the front, x direction is horizontal (perpendicular to the central line in parallel to y direction in FIGS. 9 and 10 and in parallel to a direction combining the two earholes), and y direction is vertical (in parallel to the central line) in an image. An apparatus for panoramic radiography uses an X-ray beam having a shape of a vertical slit. The improvement of a panoramic radiograph by setting Fx>Fy>0 may be ascribed to that the setting of Fx>Fy>0 corresponds to correction of X-ray intensity in vertical direction. On the other hand, a cephalo-metric image can also be improved due to a similar reason by setting Fx>Fy>0.

The edge of the mask where the mask has a value of one has a form of an ellipse in the example shown in FIG. 5, but it may have a different form, for example, a rectangle.

Further, as shown schematically in an example in FIG. 7, the DC component can be reproduced by setting the value of the mask at the origin to one. The numerical value just near the origin is set to a value smaller than one. (for example a value between 0 and 0.5), and it is increased gradually as a point in the mask leaves away from the origin. By setting the value of the mask to one at the origin, the average value of the image data can be conserved. However, this condition is not necessary. For example, it is possible to set the DC component to zero, while the image data is calculated so as to conserve the average. This processing can be omitted if the value of the mask is set to zero at the origin.

In an example shown schematically in FIG. 8, besides the above-mentioned decrease in low spatial frequency components, the mask can be applied to for high spatial frequency components in the image by decreasing the value of the mask gradually from one to zero when the spatial frequency is increased above Fh. As an example of Fh, FIG. 8 shows a frequency Fh lower than the Nyquist frequency (preferably the frequency Fh being a little lower than the Nyquist frequency). The Nyquist frequency represents a limit of spatial frequency in correspondence to an inverse of pixel pitch times two. This processing is not necessary, but it is effective to reduce noises when the original image includes noises in high spatial frequencies.

FIGS. 9 and 10 show examples of X-ray radiographs obtained in panoramic radiography before the mask processing and after the mask processing, respectively. By comparing the two radiographs, it is apparent that the image before the mask processing is too white at the left and right sides (FIG. 9) and that it becomes appropriate for diagnosis after the mask processing (FIG. 10).

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1. A method for processing an image comprising the steps of:
computing Fourier transforms in a two-dimensional frequency space on digital X-ray image data obtained by panoramic or cephalo-metric radiography;
multiplying data of the Fourier transforms by values of a mask having different frequency characteristics in two coordinate directions in the two-dimensional frequency space, the values being smaller than one around an origin in the frequency space, and
computing inverse Fourier transforms on the data of the Fourier transforms after the multiplication to provide a resultant image data in real space.

2. The method according to claim 1, wherein a frequency, at which the value of the mask becomes one as frequency is changed from an origin in a coordinate axis in the two-dimensional frequency space, is different from another frequency at which the value of the mask becomes one as frequency is changed from the origin in the other coordinate axis.

3. The method according to claim 2, wherein the first coordinate axis is horizontal coordinate axis and the other coordinate axis is vertical coordinate axis in the two-dimensional frequency space.

4. The method according to claim 3, wherein a frequency, at which the value of the mask becomes one as frequency is changed from the origin in a horizontal coordinate axis, is larger than a frequency, at which the value of the mask becomes one as frequency is changed from the origin in a vertical coordinate axis.

5. The method according to claim 1, wherein the value of the mask is one at the origin.

6. The method according to claim 1, wherein the value of the mask decreases from one when the frequency is increased above a frequency lower than Nyquist frequency.

7. The method according to claim 1, wherein the digital X-ray image data are obtained by logarithm transformation of data obtained by an X-ray sensor.

8. An apparatus for processing an image comprising:
a first computer which computes Fourier transforms in a two-dimensional frequency space on digital X-ray image data obtained by panoramic or cephalo-metric radiography;
a multiplier which multiplies data of the Fourier transforms with values of a mask having different frequency characteristics in two coordinate directions in the two-dimensional frequency space, the values being smaller than one around an origin in the frequency space; and
a second computer further computes inverse Fourier transforms on the data of the Fourier transforms after the multiplication to provide a resultant image data in real space.

9. The apparatus according to claim 8, wherein a frequency, at which the value of the mask becomes one as frequency is changed from an origin in a first coordinate axis in the two-dimensional frequency space, is different from another frequency at which the value of the mask becomes one as frequency is changed from the origin in the other coordinate axis.

10. The apparatus according to claim 8, wherein a frequency, at which the value of the mask becomes one as frequency is changed from the origin in a horizontal coordinate axis, is larger than a frequency, at which the value of the mask becomes one as frequency is changed from the origin in a vertical coordinate axis.

11. The apparatus according to claim 8, wherein the digital X-ray image data are obtained by logarithm transformation of data obtained by an X-ray sensor.

12. A computer-readable recording medium storing a program comprising the steps of:
computing Fourier transforms in two-dimensional frequency space on digital X-ray image data obtained by panoramic or cephalo-metric radiography;
multiplying data of the Fourier transforms with values of a mask having different frequency characteristics in two coordinate directions in the two-dimensional frequency space, the values being smaller than one around an origin in the frequency space; and
computing inverse Fourier transforms on the data of the Fourier transforms after the multiplication to provide a resultant image data in real space.

13. The recording medium according to claim 12, wherein a frequency, at which the value of the mask becomes one as frequency is changed from an origin in a coordinate axis in the two-dimensional frequency space, is different from another frequency at which the value of the mask becomes one as frequency is changed from the origin in the other coordinate axis.

14. The recording medium according to claim 12, wherein a frequency, at which the value of the mask becomes one as frequency is changed from the origin in a horizontal coordinate axis, is larger than a frequency, at which the value of the mask becomes one as frequency is changed from the origin in a vertical coordinate axis.

15. The recording medium according to claim 12, wherein the digital X-ray image data are obtained by logarithm transformation of data obtained by an X-ray sensor.
